(19) United States
(12) Patent Application Publication
(10) Pub. No.: US 2011/0057008 A1
(43) Pub. Date: Mar. 10, 2011

(54) SPRING ASSIST SYSTEM FOR VEHICLE-MOUNTED RACKS

(75) Inventors: Eivind Clausen, Bellingham, WA (US); James D. Allsop, Bellingham, WA (US); Ryan K. Allsop, Bellingham, WA (US)

(73) Assignee: SOFTRIDE, INC., Bellingham, WA (US)

(21) Appl. No.: 12/879,971

(22) Filed: Sep. 10, 2010

Related U.S. Application Data
(60) Provisional application No. 61/241,319, filed on Sep. 10, 2009.

(51) Int. Cl. B60R 9/06

(52) U.S. Cl. 224/504; 224/519

(57) ABSTRACT

A carrier for bicycles or other objects which is adapted to be mounted in a hitch receiver of a vehicle. The carrier being adapted to pivot downwardly away from the rear of the vehicle to allow for improved access to the rear doors of the vehicle. The carrier including one or more spring mechanisms such as cylinder and piston combinations, mounted to both control the rate of downward tilting of a rack and to assist in the lifting of the rack back to its load carrying position and release lever means for preventing loading or unloading of the cylinder and piston combinations when the rack is tilted.

### CROSS-REFERENCE TO RELATED APPLICATION

This application claims the benefit of U.S. Provisional Patent Application No. 61/241,319, filed Sep. 10, 2009, the entire disclosure of which is incorporated herein by reference.

### BACKGROUND

The present invention relates to vehicle-mounted carriers or racks and particularly to hitch-mounted racks for carrying bicycles or other goods, the rack being pivotable downwardly away from the vehicle to improve access to the rear doors of the vehicle.

Rearwardly tiltable vehicle hitch-mounted support racks are known. See, for example, U.S. Pat. Nos. 5,181,822, 5,527,146 and 5,658,119; International Publication No. WO2006/004519 A1; and U.S. Patent Publication No. 2008/0099522 A1.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A carrier for mounting in a hitch receiver at the rear of a vehicle. The carrier including a first tubular or base portion adapted to be inserted in the hitch receiver of the vehicle and a second beam portion adapted to carry bicycle mounting racks, or in other embodiments, racks for carrying other loads. The first and second portions are pivotally connected to each other such that the bicycle or load-carrying portion may be tilted downwardly to improve access to the rear storage area of a vehicle.

The carrier includes one or more spring mechanisms such as a gas assist cylinder and piston combination mounted to extend between the base portion and the beam portion to both slow the rate of downward tilting and assist in lifting the weight of the load carried on the beam portion. A bracket having a release lever is mounted on the beam portion and adapted to be interconnected with the gas assist cylinder and piston devices to allow the beam to be pivoted with or without loading or unloading the cylinder and piston combination.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a perspective view of a bicycle rack shown in the vertical position and including a gas assist cylinder and piston combination;

FIG. 2 is a perspective view of the bicycle rack of FIG. 1 including an exploded view of one side of the gas assist cylinder and piston and its mounting structure;

FIG. 3 is a right side elevation view of a bicycle in the vertical position and showing the gas assist cylinder release lever in the locked position;

FIG. 4 is a right side elevation view of the rack of FIG. 3 showing the gas assist cylinder release lever in the unlocked position;

FIG. 5 is a right side elevation view of the rack of FIG. 3 showing the rack downwardly tilted and with the release lever in locked position;

FIG. 6 is a right side elevation view of the rack of FIG. 3 showing the release lever in the unlocked position;

FIG. 7 is a bottom perspective view of the tube and beam portions of a second embodiment of a rack;

FIG. 8 is a bottom perspective view of the rack of FIG. 7 including a pair of gas assist cylinders and pistons mounted thereon;

FIG. 9 is a left side elevation view of the rack of FIG. 8;

FIG. 10 is a left side elevation view of the rack of FIG. 8 in the downwardly tilted position;

FIG. 11 is a left side elevation view of the rack of FIG. 8 in the upright storage position;

FIG. 12 is a front perspective view of the rack of FIG. 8 including the bicycle mounting elements interconnected with the beam portion of the rack and including a pair of bicycles mounted thereon;

FIG. 13 is a left side elevation view of the bicycle rack of FIG. 12; and

FIG. 14 is a left side elevation view of the bicycle rack of FIG. 12 shown in the downwardly tilted position.

FIG. 15 is a partial perspective view of the gas assist cylinder and piston combination including a pair of coil springs.

### DETAILED DESCRIPTION

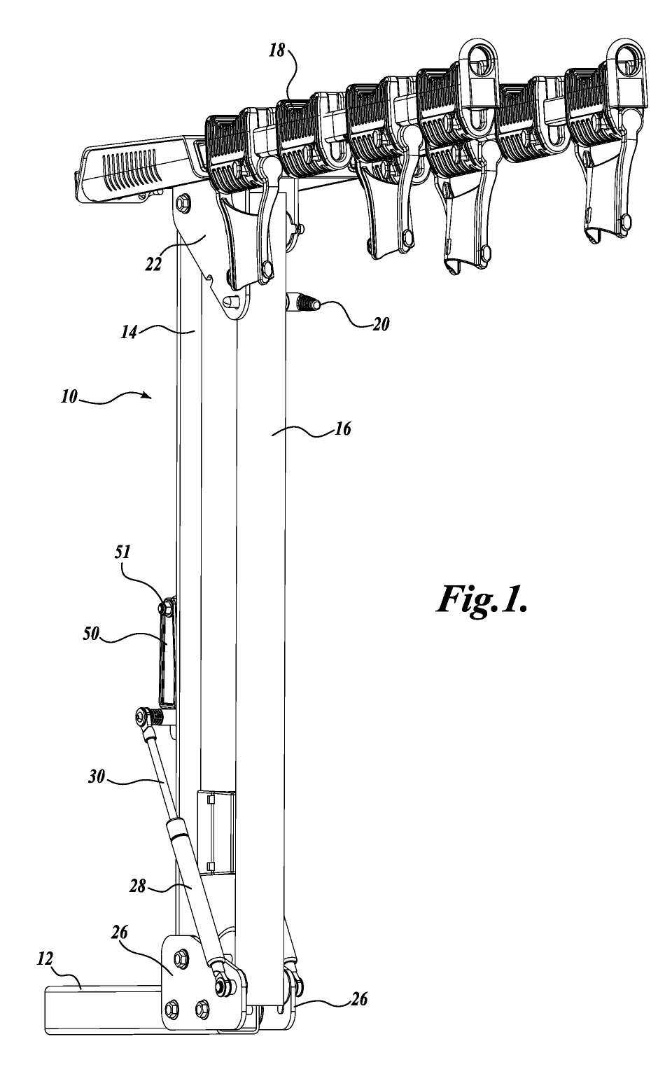

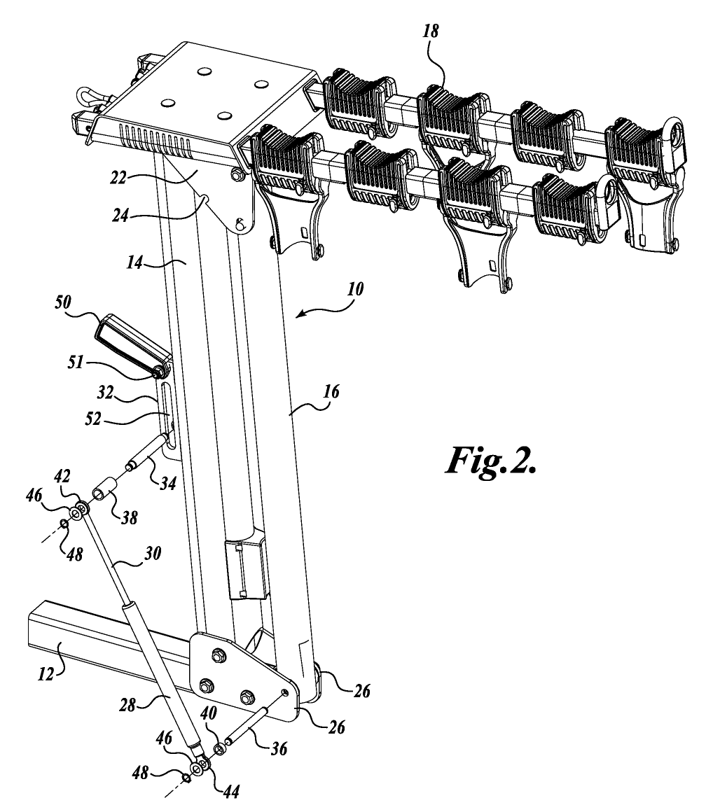

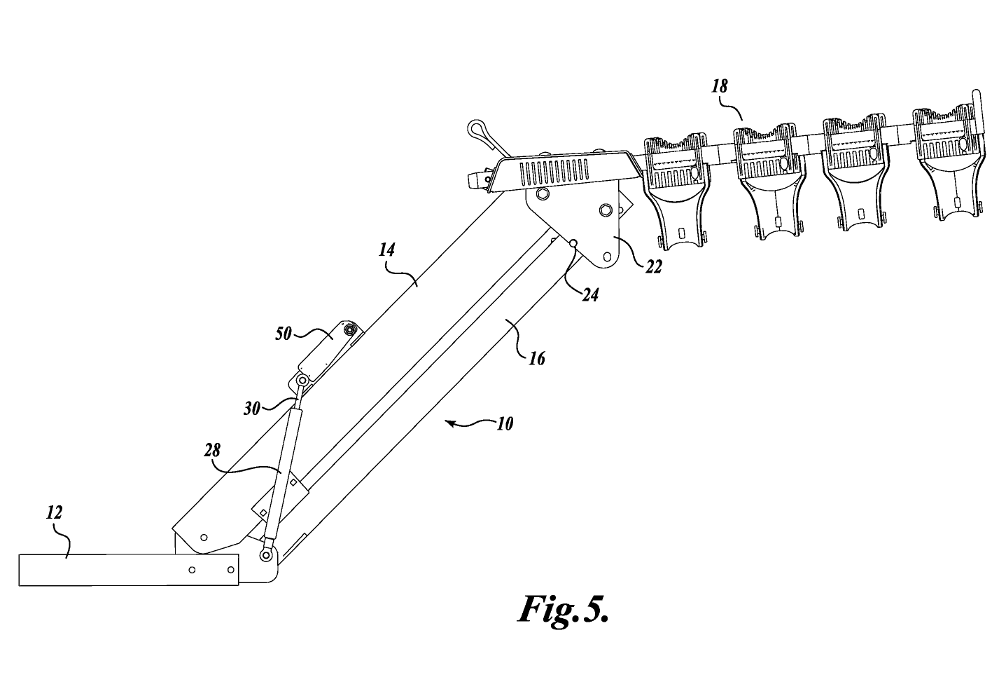

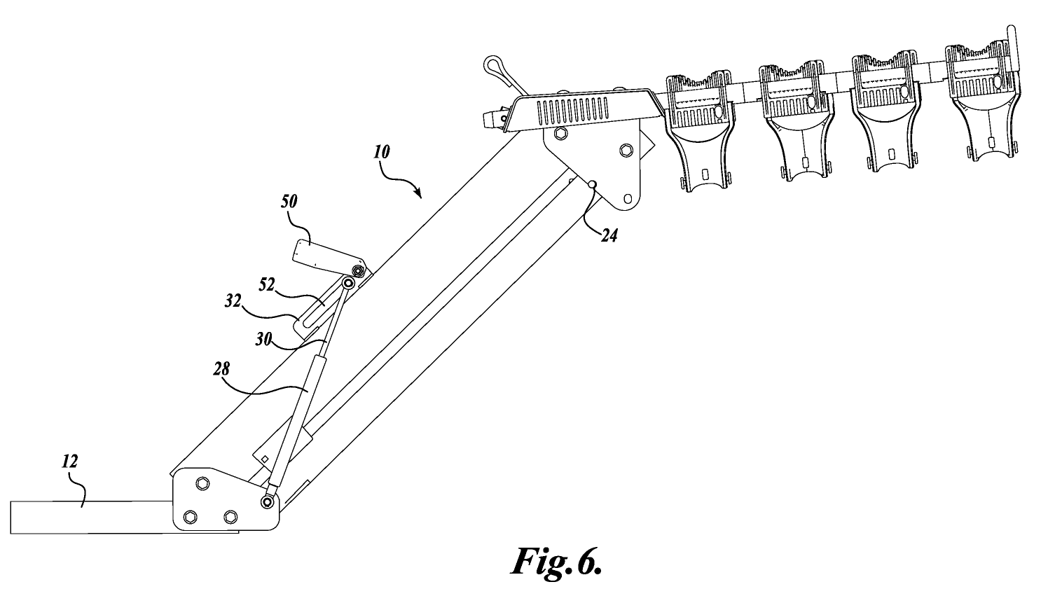

Referring initially to FIGS. 1-6, a vehicle-mounted rack 10 is disclosed including a tubular base portion 12 adapted to be inserted and mounted in the hitch receiver of a vehicle, such as a van or the like, having a rear door or doors. Extending upwardly from the base portion is a first beam member 14 and a second beam member 16 mounted rearwardly thereof vis-à-vis the vehicle. Beam members 14 and 16 are pivotally mounted at their base and extend upwardly to, and are pivotally mounted to, support arms 18. A spring-loaded pull pin 20 is provided to extend through second beam member 16 and through a corresponding hole in plate 22 to lock the rack in its upright position. Referring additionally to FIG. 2, a notch 24 may be provided in plate 22 for engagement with pull pin 20 to lock the rack in its forwardly tilted position as best seen in FIGS. 5 and 6.

The pivoting interconnection of the first and second beam members with base portion 12 and support arms 18 forms a substantial parallelogram such that when rack 10 is tilted forwardly, support arms 18 remain in a substantially horizontal position so that loads mounted thereon are not dislodged. Said base portion includes a pair of base plates 26 to pivotally interconnect the first and second beam members 14 and 16 with base portion 12 by means of pins or the like extending through the base plates and the bottom portions of the first and second beam members. The structure and operation of this rack is more fully disclosed in U.S. Patent Publication No. 2008/0093404-A1, which is hereby incorporated by reference into this application.

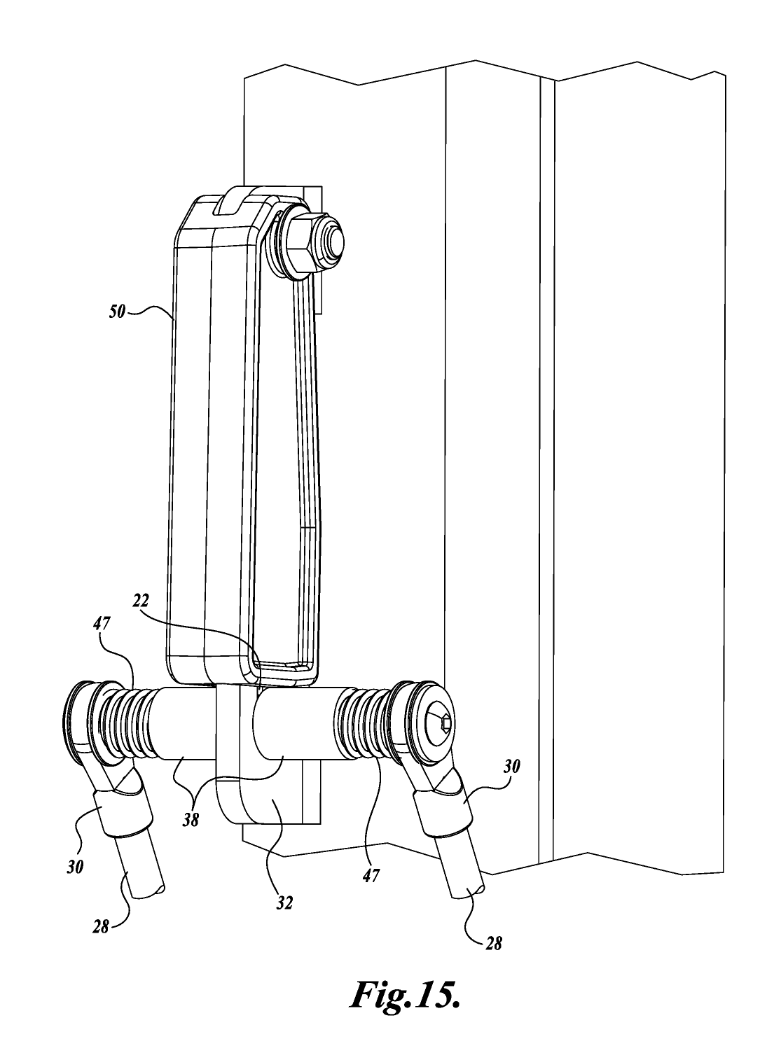

Referring again to FIG. 1, a spring mechanism such as a gas assist cylinder 28 and cooperating piston 30 are shown mounted to extend between base plate 26 and a slotted bracket or fitting 32 as seen in FIG. 2. Fitting 32 is welded or otherwise affixed longitudinally to the forward portion of beam 14. While not illustrated in FIG. 2, it will be understood that a pair of pistons and cylinders 28 and 30 may be mounted on opposite sides of carrier 10 and interconnected by upper pin 34 and lower pin 36. Pins 34 and 36 extend through spacers 38 and 40 and cooperating fittings 42, and 44, connected, respectively, to the end of the piston rod 30 and to the end of the cylinder 28. Pin 36 also mounts the lower end of pivotable beam member 16 to the pair of base plates 26. The ends of pins 34 and 36 are held in place by cooperating washers 46 and retaining rings 48. Referring to FIG. 15, to take up any looseness in the connection and to prevent rattle, coil springs 47 may be placed adjacent the spacers 38 and 40, or elsewhere on pins 34 and 36.

While the spring mechanism illustrated in the preferred embodiment is shown to be a gas assist cylinder and piston combination, it will be understood that other mechanisms capable of operating as a spring may alternatively be used including a gas spring with dampening oil inside the cylinder, coil springs, or leaf springs.

Release lever 50 is mounted on conventional pivot pin structure 51 at the upper end of bracket or fitting 32. The release lever comprises a U-shaped channel adapted to fit over bracket 32 when in the closed position, thus forming a blocking means preventing movement of the end of piston rod 30 in slot 52.

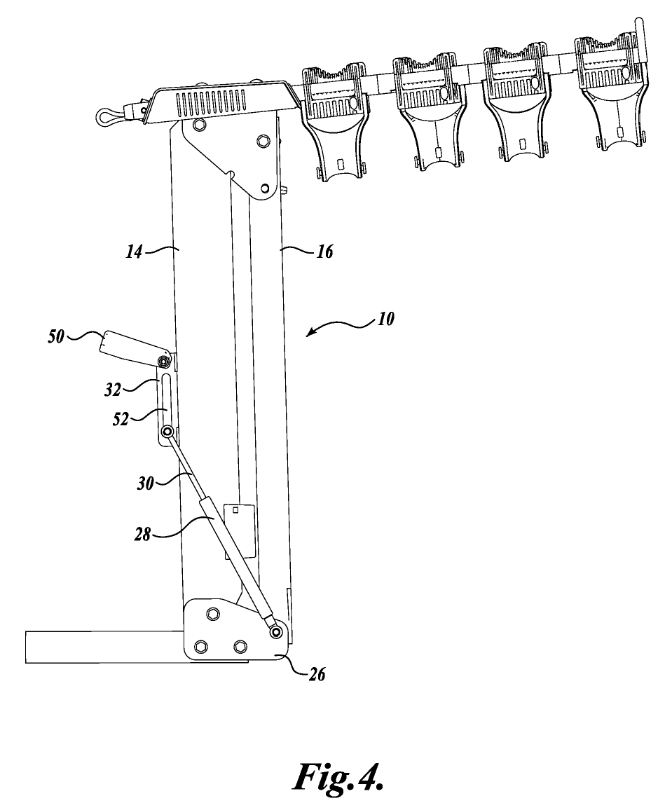

FIGS. 2 and 4 show pivotal release lever 50 in the open position. In this position, the end of piston rod 30 may slide longitudinally in slot 52 of fitting 32 such that when the rack is tilted downwardly, no force is applied to press piston rod 30 into cylinder 28 to compress the gas therein and thereby slow the rate of tilting of the rack 10. See FIG. 6 also.

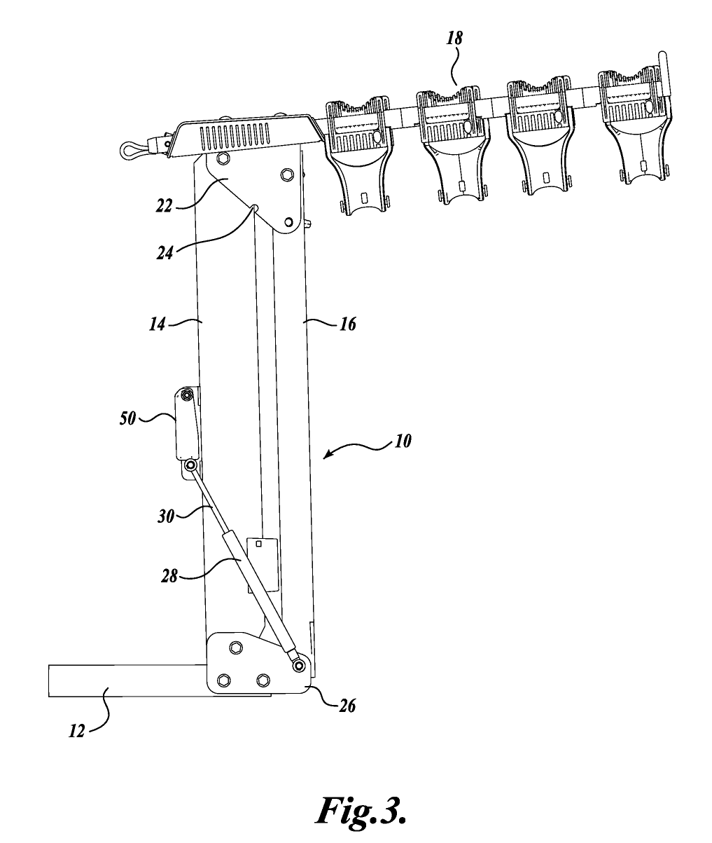

In FIGS. 3 and 5, however, release lever 50 is shown in the downward, locked and blocking position where it prevents the end of piston rod 30 from sliding in slot 52 such that when rack 10 is tilted rearwardly, as best seen in FIG. 5, piston rod 30 is pressed downwardly into cylinder 28 to compress the gas within the cylinder, thus not only slowing the tilting of the rack, but also storing energy which can later be used to assist in raising the rack to its original upright position.

It is also contemplated that the spring mechanism could be fixedly attached to extend between beams 14 and 16 such that the spring mechanism would always be operable. For example, a first end of the spring mechanism could be attached to beam 14 a vertical distance above its connection to base portion 12 while the second end of the spring mechanism is connected to beam 16 near its base. Other connection points are also contemplated.

It will be understood that when a load is placed upon support arms 18 when the carrier is in its upright position, release lever 50 will be moved to the closed and locked position. However, when it is desired to tilt rack 10 when there is no load on the rack and it is simply desired to move the rack out of the way so that the rear doors of the vehicle may be opened, releasing the lever 50 allows the rack to tilt freely without encountering any resistance from the gas assist piston and cylinder 28 and 30.

The combination of the spring mechanism such as a gas assist cylinder and piston and the parallelogram rack creates a novel and improved vehicle mounting rack which assists in overcoming the serious problems encountered when tilting and raising a rack supporting a significant load such as would be encountered when four bicycles are mounted thereon. The gas assist piston and cylinder combinations, both prevent the rack from tilting too rapidly, which can be both dangerous to the user and damaging to the rack and its load and, in addition, the stored energy in the compressed gas cylinder assists in raising the rack from the downwardly tilted position. Notch 24 is provided in plate 22 to receive pull pin 20 to hold the rack in a tilted position so that the stored energy in the cylinder and piston combination does not raise the rack prematurely. Once spring-loaded pull pin 20 is pulled out of notch 24, however, and the rack begun to be raised, piston 30 is pushed out of cylinder 28 by the compressed gas to assist in raising the rack.

As shown in FIGS. 2-6, cylinder 28 is mounted to base plate 26 by means of pin 36, while piston 30 rides in the slot 52 of fitting 32. It will be understood, however, that the position of the piston rod and cylinder may be reversed.

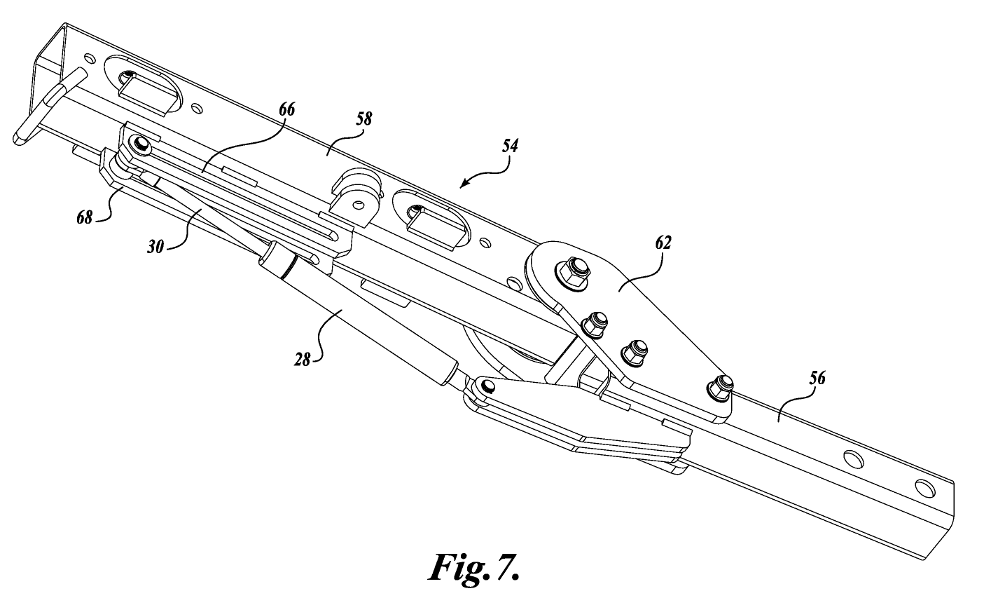

Turning now to FIGS. 7-11, cylinder 28 and piston rod 30 are shown mounted on a second form of vehicle-mounted rack 54 comprising a base portion 56 which is adapted to be received into a hitch receiver at the rear of a vehicle, and a beam portion 58 which is pivotally connected thereto by a pair of plates 60 and 62 positioned on the opposite sides of the base portion and the beam portion, and conventional fasteners such as nuts and bolts, the beam portion 58 may pivot both downwardly and upwardly with respect to base portion 56. The structure and operation of this rack is more fully disclosed in U.S. Patent Publication No. 2008/0099522-A1, which is hereby incorporated by reference into this application.

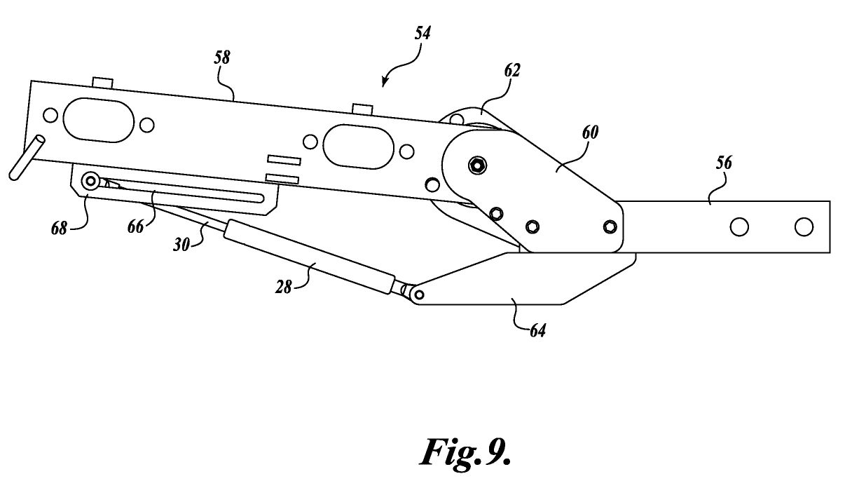

Referring additionally to FIG. 9, the forward end of cylinder 28 is shown connected to cantilevered mounting plate 64 disposed on the bottom of base portion 56. It will be understood that cylinder 28 is mounted to pivot with respect to mounting plate 64. The end of piston rod 30 is mounted to move longitudinally in slot 66 of bracket 68 which is welded or otherwise mounted to extend longitudinally on the bottom of beam 58. As best shown in FIG. 7, bracket 68 may include a pair of downwardly extending longitudinal members, each of which includes a slot 66 in which the end of piston rod 30 moves.

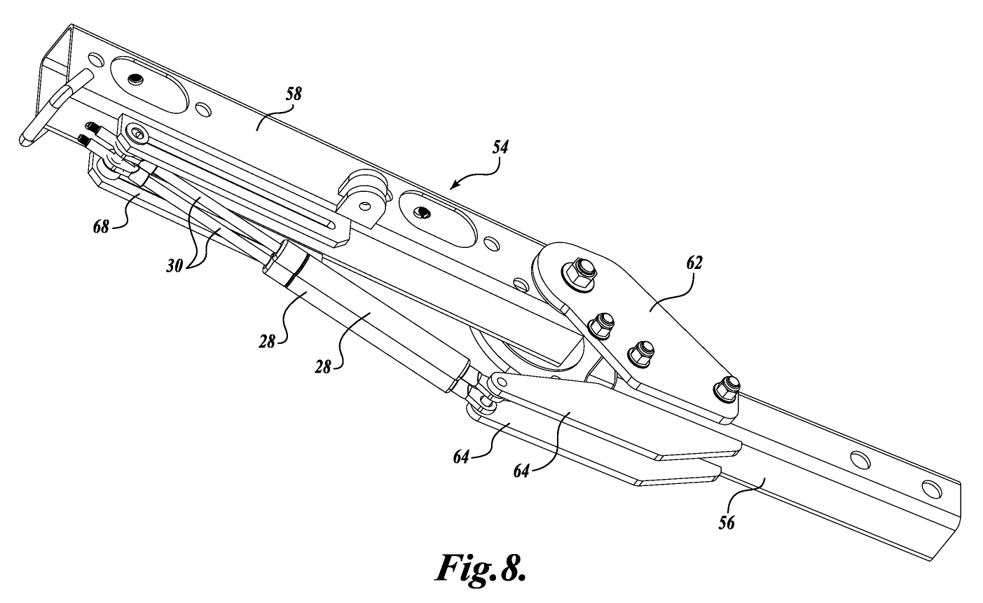

Referring additionally to FIG. 8, an alternate embodiment in which a pair of spring mechanisms such as parallel gas assist cylinders comprising cylinders 28 and piston rods 30 are shown. The use of a pair of spring mechanisms would create additional force to assist in either slowing the tilt of beam 58 downwardly or raising it upwardly. The use of single or double gas assist cylinders, or cylinders of greater or lesser size, is a matter of choice to be determined by the parameters of the rack design and the load to be carried.

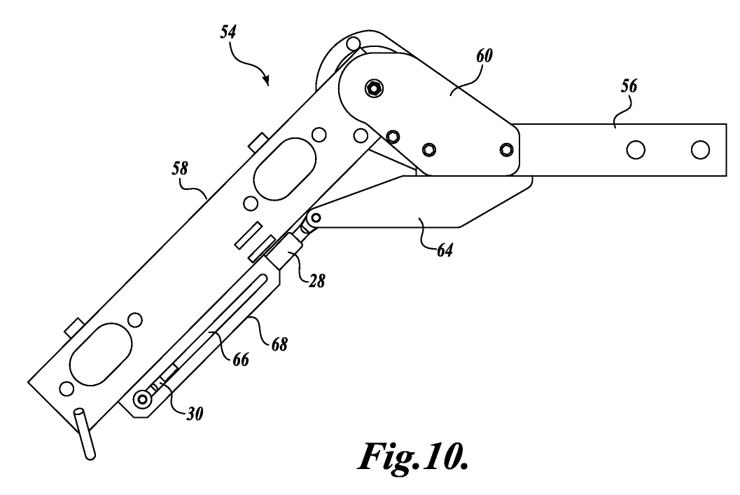

Turning now to FIG. 10, rack 54 is shown in the downwardly tilted position. When so tilted, piston rod 30 is moved into cylinder 28 to compress the gas therein. The end of piston rod 30 remains pressed against the end of slot 66 while cylinder 28 moves within slot 66 as the piston rod 30 moves into the cylinder. Again, it will be understood that either single or double sets of gas assist cylinders as shown in FIG. 8, may be used. It has been found that a pair of 130-pound rated gas assist pistons works satisfactorily to handle normal bicycle rack loads, but it will be understood that gas assist cylinders of larger or smaller ratings could be used as required in either this embodiment or the embodiment of FIGS. 1-6.

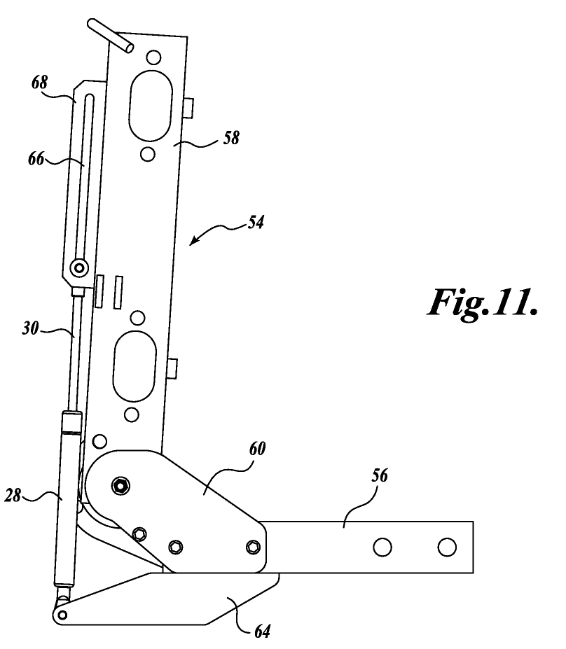

Turning now to FIG. 11, beam 58 is shown pivoted upwardly such as would be the case when it is not loaded and it is desired to reduce the length which the rack extends rearwardly of the vehicle. In this configuration, the distal end of piston rod 30 moves to the proximal end of slot 66. In this arrangement, the gas within cylinder 28 is not compressed. The cantilevered mount of plate 64 allows cylinder 28 to be moved to the vertically upright position when the beam is tilted upwardly for storage.

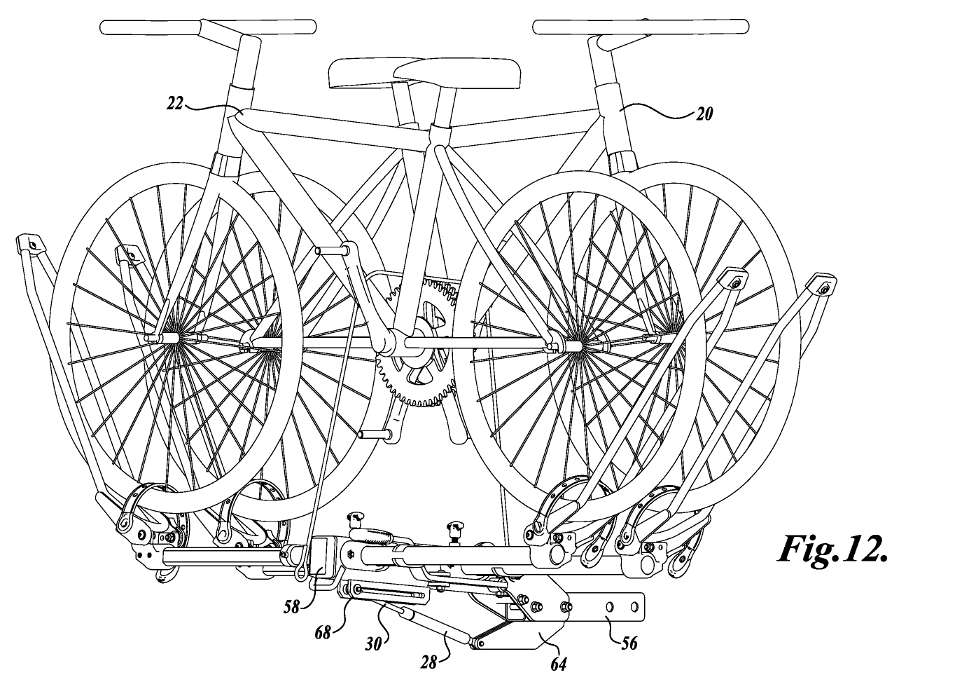

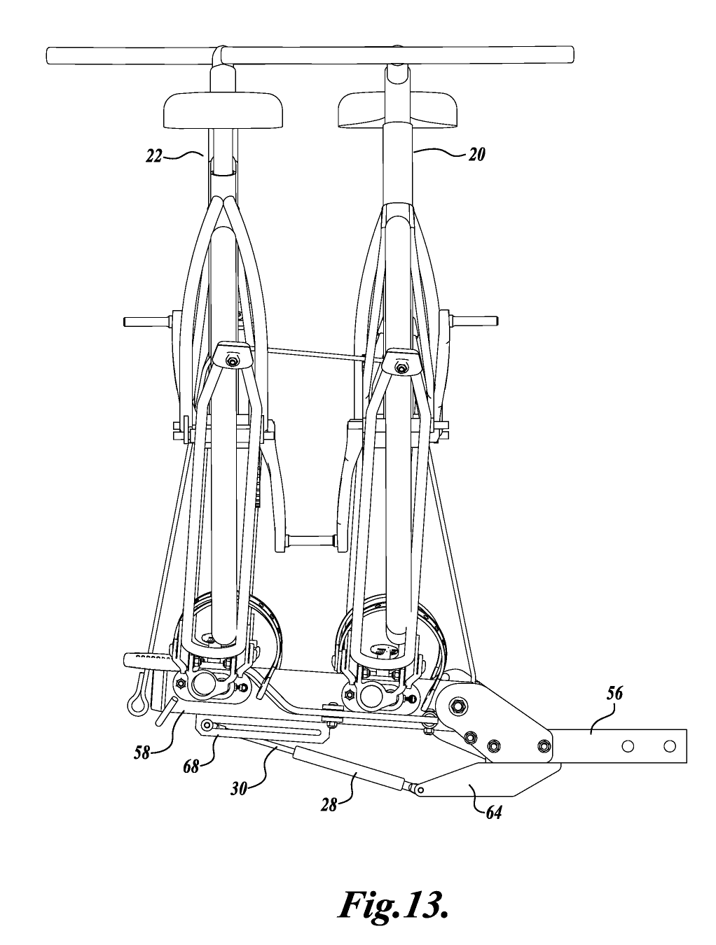

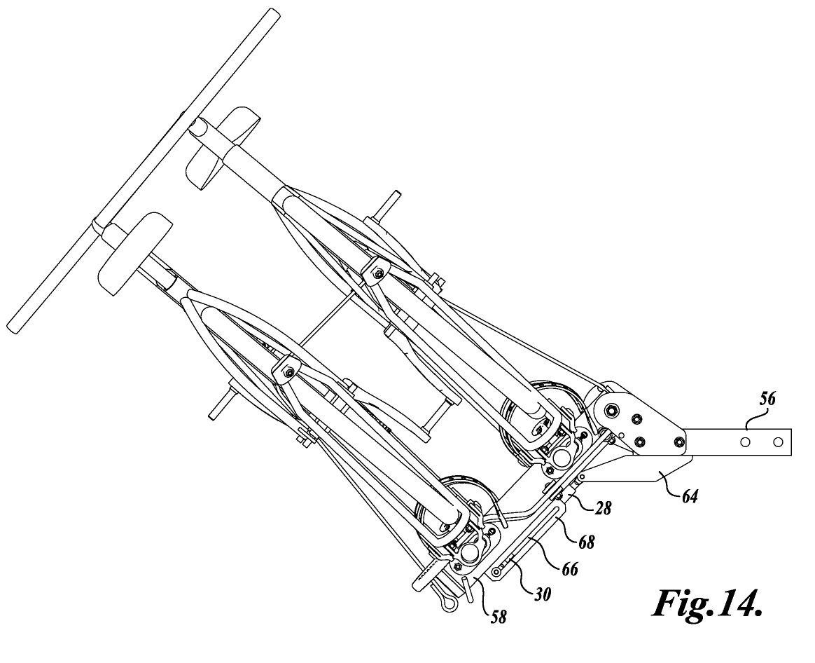

FIGS. 12-14 illustrate the rack of FIGS. 7-11 with structure for holding a pair of bicycles mounted to pivoting beam portion 58. The full details of this bicycle mounting structure may be seen in U.S. Patent Publication No. 2008/0099522-A1 identified above and incorporated herein by reference. As shown in FIGS. 12 and 13 bicycles 70 and 72 are carried in an upright position on the rear of a vehicle. When access to the rear doors of the vehicle is needed, a spring loaded pull pin is withdrawn from its locked position such that the beam portion 58 tilts downwardly. As the beam tilts downwardly, piston rod 30 moves toward cylinder 28 to compress the gas within cylinder 28 thus slowing the speed at which beam portion 58 tilts. Controlling the speed of the tilting motion reduces the risk of injury to the user or damage to the load which could be caused by the sudden tilting of a heavy load if it were not properly controlled by the user. When it is desired to return beam portion 58 to its horizontal position as shown in FIGS. 12 and 13, the force of the compressed gas within cylinder 28 helps the user tilt the load upwardly. This is particularly important when the load being carried on beam 58 is a heavy one.

In some instances where it is desired to carry a load other than bicycles, the bicycle carrying structure shown in FIGS. 12-14 may be replaced by a tray type carrier mounted on beam portion 58. Such a carrier is illustrated in the U.S. patent publication identified above and incorporated herein by reference. This type of carrier may support loads much heavier than bicycles, thus making the benefit of the spring assist design even more important when beam portion 58 is tilted downwardly or upwardly.

While the preferred embodiment of the invention has been illustrated and described, it will be appreciated that various changes can be made therein without departing from the spirit and scope of the invention.

1. In a pivotable vehicle-mounted carrier having a base portion adapted to be mounted in a hitch receiver at the rear of a vehicle and a beam portion pivotally connected to said base portion and adapted to pivot in a vertical plane:
at least one spring mechanism comprising a cylinder and piston combination mounted to extend between said base portion and said pivotable beam portion to slow the rate of descent of said beam portion when it is pivoted downwardly and to assist in raising said beam portion when it is pivoted upwardly;
a bracket having an elongate slot mounted to said beam portion, wherein one end of said cylinder and piston combination is connected to said base portion and the opposite end of said cylinder and piston combination is connected to slide along said slot in said bracket mounted; and
blocking means to selectively prevent said opposite end of said cylinder and piston combination from sliding along said slot.

2. The pivotable vehicle-mounted carrier of claim 1, wherein said at least one cylinder and piston combination comprises a pair of cylinder and piston combinations extending between said base portion and said pivotable beam portion in substantially parallel relationship to each other; and
said opposite ends of said cylinder and piston combinations connected to said beam portion being mounted on opposite ends of a rod extending through said slot in said bracket mounted on said beam portion, said rod being adapted to either slide in said slot or be held adjacent one end thereof by a blocking means.

3. The pivotable vehicle-mounted carrier of claim 1, wherein said blocking means comprises a pivotable release lever movable between a locked position and an unlocked position.

4. The pivotable vehicle-mounted carrier of claim 3, wherein when said pivotable release lever is in said locked position, the cylinder and piston combination acts to slow the rate of descent of said beam portion when said beam portion is pivoted downwardly, and acts to assist in lifting said beam portion when said beam portion is pivoted upwardly.

5. The pivotable vehicle-mounted carrier of claim 1, wherein said base portion includes a forward portion adapted to be mounted within said hitch receiver and at least one base plate mounted on a rearward end of said base portion; and
said one end of said cylinder and piston combination is connected to said at least one base plate.

6. The pivotable vehicle-mounted carrier of claim 5, wherein the at least one base plate comprises a pair of base plates mounted on opposed lateral sides of the rearward end of said base portion; and further comprising pin means extending laterally through said pair of base plates and through said one end of said cylinder and piston combination.

7. The pivotable vehicle-mounted carrier of claim 3, wherein said pivotable release lever is pivotally connected to the upper end of said bracket such that when said lever is pivoted away from said bracket, said opposite end of said cylinder and piston combination may slide in said slot and when said release lever is pivoted inwardly to align with said bracket, said opposite end of said cylinder and piston combination is held in a lower end of said slot.

8. A pivotable vehicle mounted carrier having a base portion and first and second upright members pivotally connected to said base portion;
a spring mechanism having a first end pivotally connected to said first upright member; and
a second end pivotally connected to said second upright member.

9. The pivotable vehicle mounted carrier of claim 8, including pin means pivotally connecting said second end of said spring mechanism to said second upright member, said pin means extending through said base portion, the second end of said spring mechanism, and said second upright member.

10. The pivotable vehicle mounted carrier of claim 8, wherein said spring mechanism comprises at least one cylinder and piston combination.

11. In a pivotable vehicle-mounted carrier having a base portion adapted to be mounted in a hitch receiver at the rear of a vehicle and a beam portion attached to said base portion and configured to pivot in a vertical plane:
a spring mechanism comprising a gas assist cylinder and piston mounted in combination to extend between said base portion and said beam portion, said gas assist cylinder configured to slow the downward pivoting of said beam portion and to assist in pivoting said beam upwardly.

12. The pivotable vehicle-mounted carrier of claim 11, wherein said piston moves into said cylinder to compress a gas therein when said beam portion is pivoted downwardly and wherein said compressed gas pushes said piston upwardly within said cylinder when said beam portion is pivoted upwardly.

13. A vehicle-mounted carrier having a base portion adapted to be mounted in a hitch receiver on the rear of a vehicle and a beam portion attached to said base portion and configured to pivot in a vertical plane between a downwardly tilted position, a horizontal load-carrying position and a vertical storage position;
said base portion including a mounting plate and said beam portion including a slotted mounting bracket;
at least one spring mechanism comprising a cylinder and piston combination mounted to extend between said base portion mounting plate and said beam portion slotted mounting bracket such that a first end of said cylinder and piston combination is slidably connected to said slotted bracket and adapted to move therein as said piston moves into and out of said cylinder and a second end of said cylinder and piston combination is pivotally connected to said mounting plate; and
said cylinder and piston combination adapted to slow the downward tilting of said beam portion from said horizontal load-carrying position and to assist in the upward tilting of said beam portion from said downwardly tilted position.

14. The vehicle-mounted carrier of claim 13, wherein said first end of said cylinder and piston combination comprise an end of the piston rod.

15. The vehicle-mounted carrier of claim 13, wherein the base portion mounting plate is cantilevered rearwardly and the point of connection of said cylinder and piston combination is at said cantilevered end such that said cylinder and piston combination may be pivoted vertically upward as said beam portion is pivoted upwardly to said vertical storage position.

16. A carrier adapted to be mounted on the rear of a vehicle comprising a base portion having a beam portion pivotally connected thereto;
a cylinder and piston means interconnected between said base portion and said beam portion;
a base portion mounting plate mounted on said base portion and a beam portion mounting bracket mounted on said beam portion, said beam portion mounting bracket extending longitudinally along said beam portion and including a longitudinally extending slot;
one end of said cylinder and piston combination adapted to move in said slot when said beam portion is pivoted with respect to said base portion, the other end of said cylinder and piston combination being pivotally mounted in a fixed position to said base portion mounting plate.
